(19) United States
(12) Patent Application Publication
(10) Pub. No.: US 2003/0012308 A1
(43) Pub. Date: Jan. 16, 2003

(54) Adaptive channel estimation for wireless systems

(76) Inventors: Hemanth T. Sampath, Stanford, CA (US); Joe Tellado, Mountain View, CA (US)

Correspondence Address: Iospan Wireless Inc., Patent Department, P.O. Box 641867, San Jose, CA, 95164-1867, US

(21) Appl. No.: 09/880,574

(22) Filed: Jun. 13, 2001

(51) Int. Cl. H04L 27/06

(52) U.S. Cl. 375/340

(57) ABSTRACT

The present invention provides a method and apparatus for performing channel estimation in a wireless system including the steps of receiving a signal including training symbols embedded within data symbols, estimating training channel responses for the training symbols, and adapting an interpolator for generating data channel responses for the data symbols by interpolating the training channel responses. The present invention provides a subscriber unit for receiving a wireless signal including training symbols embedded within data symbols, the subscriber unit including a response estimator for estimating the training channel responses for the training symbols and an adaptive interpolator for generating data channel responses for the data symbols by interpolating the training channel responses. The present invention provides a wireless system including a transmitter for transmitting a signal including training symbols embedded within data symbols and a subscriber unit including a response estimator for estimating training channel responses for training symbols and an adaptive interpolator for generating data channel responses for data symbols by interpolating the training channel response.

### BACKGROUND OF THE INVENTION

1. Field of the Invention

The present invention relates in general to the field of wireless systems; more particularly, the present invention relates to a method and apparatus for using adaptive channel interpolation to perform channel estimation in orthogonal frequency division multiplexing systems.

2. Description of Related Art

In wireless systems, information is transmitted from a transmitter through a wireless medium to a receiver. The transmitted information can include sound, images, and/or data. Applications of wireless systems include television, FM radio, wireless computer networking, and private and public mobile communications.

The information to be transmitted (“transmitted information”) is encoded into a sequence of symbols and modulated to produce a signal. The signal is launched into a wireless medium and arrives at a receiver along the number of distinct paths, referred to as multipaths. These paths arise from scattering and reflection of radiated energy from objects such as buildings, hills, and trees. Each of these paths has a distinct propagation loss, path delay, angle of arrival, and signal amplitude. The relationship between the signal as received (“received signal”) and the signal as transmitted (“transmitted signal”) is known as the channel response. The channel response can distort the transmitted signal to such a degree that the receiver is not able to accurately decode some of the transmitted information. Inaccurate decoding leads to increased errors and decreased information transmission rates.

The receiver may compensate for the distortion by periodically estimating the channel response and multiplying the inverse of the channel response with the received signal to estimate the transmitted signal. The receiver performs channel estimation by receiving known training symbols from the transmitter. The receiver compares the training symbols as received to the training symbols as transmitted to estimate the channel. The receiver is generally able to more accurately decode the transmitted signal when it can more accurately estimate the channel response. Thus, a better channel estimate generally reduces errors and increases information transmission rates.

Orthogonal frequency division multiplexing (OFDM) is a method of providing reliable wireless communications over channels with multipaths delay spread and fading. In OFDM systems, the bandwidth is divided into many narrow frequency bands (“tones”) over which symbols are encoded and transmitted.

OFDM systems transmit signals having training symbols embedded within data symbols. The transmitted information is encoded onto data symbols that are modulated onto data tones. A known pattern is encoded onto training symbols and modulated onto training tones. The receiver can measure the channel response for the training symbols (“training channel responses”) by comparing training symbols as received (“received training symbols”) with the corresponding training symbols as transmitted (“transmitted training symbols”). The channel response of the data symbols (“data channel responses”) are estimated by applying an interpolation filter to the training channel responses. The design of the interpolation filter impacts the accuracy of the channel estimation. The resulting channel estimate is used to decode the transmitted information.

Delay spreads are the time difference between the arrival time of the signal through the fastest path and the arrival time of the signal through the slowest path. Delay spreads can vary greatly depending on the environment. Towards one extreme, in a flat rural area without mountains, hills, or tall buildings, the delay spread can be as small as 75 nanoseconds. In indoor environments, the delay spread can be smaller. Towards the other extreme, in a mountainous area or large city where there are numerous transmission paths, delay spreads as large as 20 microseconds have been reported.

Channel interpolation filters for OFDM systems are generally designed to work for fixed parameters, such as training tone spacing and interpolator length, and are generally optimized to interpolate training tones for signals having a typical delay spread. If the interpolation filter receives a signal having a smaller delay spread or larger delay spread, channel estimation errors can increase. An increase in channel estimation errors generally leads to higher decoding error rates, lower information transmission rates, and/or lower signal to noise ratios.

There is a need for a method and apparatus to accurately perform channel estimation in a broad range of system environments.

### SUMMARY OF THE INVENTION

The present invention provides methods and apparatus for performing channel estimation in a wireless system including the steps of receiving a signal including training symbols embedded within data symbols, estimating training channel responses for the training symbols, and adapting an interpolator for generating data channel responses for the data symbols by interpolating the training channel responses.

The present invention provides a subscriber unit for receiving a signal including training symbols embedded within data symbols, the subscriber unit including a response estimator for estimating the training channel responses for the training symbols and an adaptive interpolator for generating data channel responses for the data symbols by interpolating the training channel responses.

The present invention provides a wireless system including a transmitter for transmitting a signal including training symbols embedded within data symbols and a receiver including a response estimator for estimating training channel responses for the training symbols and an adaptive interpolator for generating data channel responses for the data symbols by interpolating the training channel responses.

### BRIEF DESCRIPTION OF THE DRAWINGS

FIG. 1 shows an embodiment of a single antenna wireless system of the present invention.

FIG. 2 shows an embodiment of a Multiple Input, Multiple Output (MIMO) communication system of the present invention.

FIG. 3 illustrates one embodiment of a signal having data symbols and training symbols.

FIG. 4 illustrates a first embodiment of a subscriber unit of the present invention.

FIG. 5 illustrates a second embodiment of a subscriber unit of the present invention.

FIG. 6 illustrates a third embodiment of a subscriber unit of the present invention.

FIG. 7 is a flow chart of a first method of performing channel estimation according to the present invention.

FIG. 8 is a flow chart of a second method of performing channel estimation according to the present invention.

### DETAILED DESCRIPTION

A method and apparatus is disclosed for performing channel estimation in a broad range of system environments. In one embodiment, the channel estimation is adapted based on one or more system characteristics, such as delay spread, Doppler spread, noise, interference, modulation order, training tone location, training tone density, number of transmit antennas, spatial configuration of transmit antennas, and/or transmit diversity mode.

In one embodiment, the channel estimation is adapted according to the estimated delay spread to produce more accurate channel estimates in a broad range of delay spread environments. More accurate channel estimation generally reduces error rates for a given data transmission rate and/or increases data transmission rates for given error rate.

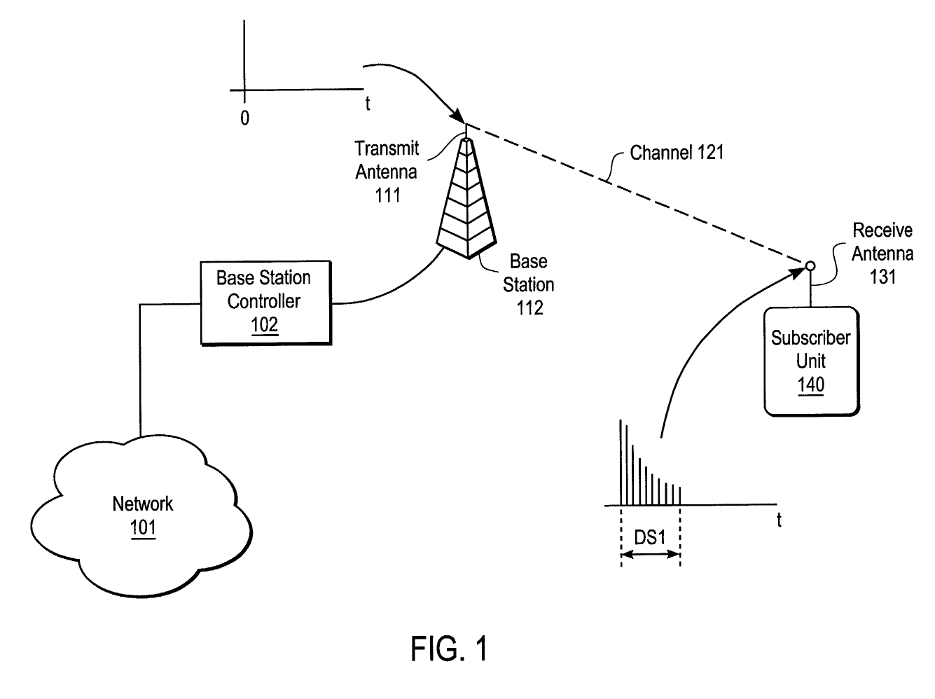

FIG. 1 illustrates one embodiment of a single antenna wireless system of the present invention. The wireless system includes a network 101, a base station controller 102, a base station 112, a transmit antenna 111, and a subscriber unit 140 having a receive antenna 131. In such a system, communications links are established between individual transmitters and individual receivers.

In one embodiment, the base station controller 102 controls the transmit antenna 111 to transmit a signal (“transmitted signal”) encoded using an orthogonal frequency division multiplexing (OFDM) protocol. In OFDM systems, the bandwidth is divided into many narrow frequency bands (“tones”). The information to be transmitted (“transmitted information”) is encoded into a sequence of data symbols and modulated onto data tones. A training pattern is encoded onto training symbols and modulated onto training tones. This training pattern may be, for example, a pseudo-random sequence known to the receiver, a sequence stored at the receiver, or data symbols correctly demodulated and decoded by the receiver. The training symbols are embedded within the data symbols over the bandwidth of the transmitted signal.

The signal as received (“received signal”) by the receive antenna 131 has a delay spread, DS1, due to multipaths. The delay spread can range from less than 75 nanoseconds to more than 20 microseconds, depending on the environment. In a more moderate environment the delay spread may be on the order of 5 microseconds.

The subscriber unit 140 contains one embodiment of an adaptive channel estimator described herein. Channel estimators estimate the training channel responses for the training symbols, and interpolate the training channel responses to estimate the data channel responses for the data symbols.

In one embodiment, the adaptive channel estimator adapts based on one or more system characteristics. In another embodiment, the adaptive channel estimator adapts based on an estimated delay spread to provide more accurate channel estimation across a broad range of delay spread environments.

The subscriber unit 140 may be fixed, portable, or mobile. The subscriber unit 140 may be a desktop computer, a notebook computer, a personal digital assistant, a television, a radio, a cellular phone, a device mounted in a vehicle, or any other device for which wireless capability is included. In one embodiment, the subscriber unit is a receiver for receiving the transmitted signal.

The network 101 may include a local area network, a wide area network, a public switched telephone network, public land mobile network, a virtual private network, an ad hoc network, an intranet or an internet. The network 101 may be coupled to the base station controller 102 through a central office, a master switching center, a ground-based relay station, satellites, base stations, and/or subscriber units. The apparatus and methods of the present invention may be implemented on a dedicated wireless infrastructure or may be superimposed on existing wireless systems.

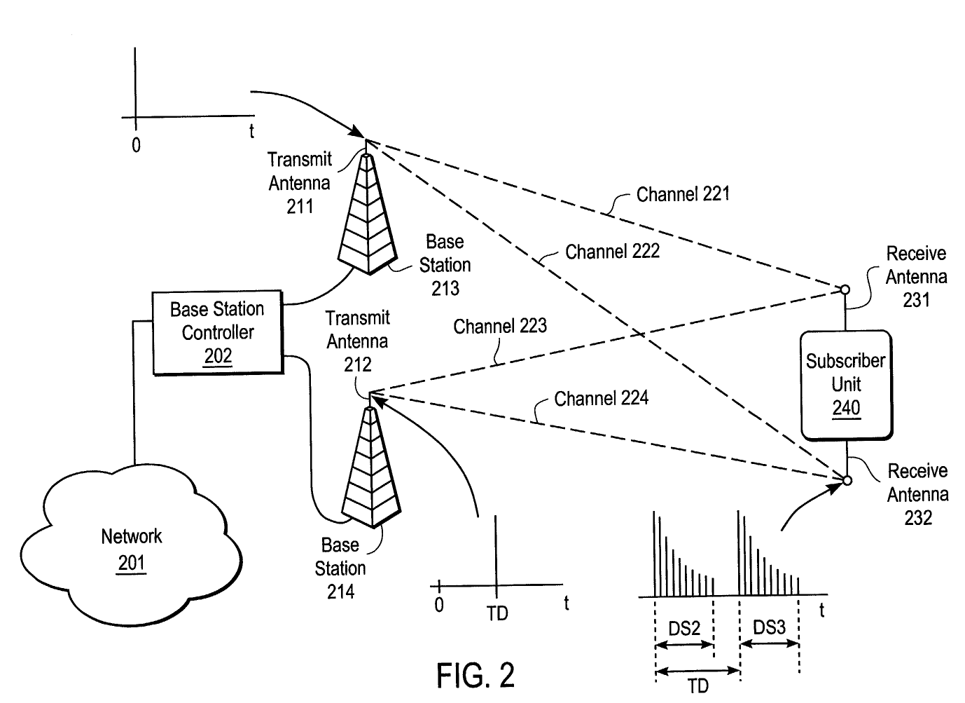

FIG. 2 illustrates an embodiment of a multiple input, multiple output (MIMO) wireless system of the present invention. The wireless system includes a network 201, a base station controller 202, a base station 213, a base station 214, a transmit antenna 211, a transmit antenna 212, and a subscriber unit 240 having a receive antenna 231 and a receive antenna 232. The network 201 and the subscriber unit 240 may have numerous embodiments including those described herein for the network 101 and the subscriber unit 140, respectively.

The base station controller 202 is configured to control the base station 213 to transmit a first signal from the transmit antenna 211 over a channel 221 to the receive antenna 231 (a first transmit-receive antenna pair) and the first signal from the transmit antenna 211 over a channel 222 to the receive antenna 232 (a second transmit-receive antenna pair). The base station controller 202 is configured to control the base station 214 to transmit a second signal from the transmit antenna 212 over a channel 223 to the receive antenna 231 (a third transmit-receive antenna pair) and the second signal from the transmit antenna 212 over a channel 224 to the receive antenna 232 (a fourth transmit-receive antenna pair).

Multiple antennas may be included in each base station. In one embodiment, a base station controller controls a base station to transmit signals from multiple antennas on that base station to a subscriber unit. In one embodiment, the wireless system of FIG. 2 is configured to perform spatial multiplexing. In one embodiment the base station controller 202 employs transmit diversity. The base station controller 202 transmits the first signal from the antenna 211 and, after transmit delay, transmits the second signal from the antenna 212. The receive antenna 232 receives the first signal with a delay spread, DS2, and the second signal having a delay spread, DS3, and delayed with respect to the first signal by a transmit delay, TD.

In one embodiment, the adaptive channel estimator receives the first and second signal and adapts to the first and second delay spreads and the transmit delay. In another embodiment, the first and second signals are separated and routed to separate adaptive channel estimators, each adaptive channel estimator adapting to the delay spread corresponding to that signal.

The subscriber unit 240 includes one embodiment of an adaptive channel estimator described herein. In one embodiment, the adaptive channel estimator adapts based on an estimated delay spread to provides more accurate channel estimation across a broad range of delay spread environments. More accurate channel estimation generally reduces error rates for a given data transmission rate and increases data transmission rates for given error rate.

Better performance may be obtained using more transmit and receive antennas. However, additional antennas may increase the cost of the communication system. In one embodiment, the base station controller(s) coordinates transmissions from two transmit antennas to a subscriber unit having 3 receive antennas. In another embodiment, the subscriber unit has one transmit antenna configured to establish a communication link with 3 receive antennas coupled to the base station controller. However, the present invention may be practiced using other configurations of transmit and receive antennas.

The present invention is not limited to any particular type of information or protocol. The information may include audio, video, and/or other data. The information may be transmitted using protocols such as a quasi-OFDM protocol, a code division multiplex protocol, a wavelet transform protocol, a frequency hopping protocol, a single carrier protocol or other protocols for which channel estimation may be employed.

In one embodiment, the transmitted information can be encoded using several levels of coding depending on the channel conditions. Higher coding levels permit higher information transmission rates but are more sensitive to noise. When channel conditions are better, the transmitter may use higher coding level to obtain higher transmission rates. When channel conditions are worse, the transmitter may use a lower coding level to avoid high error rates. In some cases, the more accurate channel estimates using the method and apparatus of the present invention enable higher coding levels for a given error rate and/or lower packet error rates for a given coding level.

The present invention may be practiced using a signal including training symbols embedded within data symbols. In one embodiment, the information is transmitted in a signal including a sequence of metaframes, each metaframe being a sequence of frames and each frame being a sequence of slots. Each slot has one of several formats. Some slots provide header information for the frame, such as identification of the subscriber unit, the coding level for the frame, and whether spatial multiplexing or transmit diversity is enabled for the frame. Other slots enable synchronization to estimate the automatic gain control parameters, timing phase, timing frequency, and frequency offset.

A data slot is used in low mobility situations or where the channel conditions do not change frequently. The data slot does not include training symbols, so the subscriber unit uses the channel estimation obtained for the header slot. In a preferred embodiment, the data slot has 1024 tones, 840 of the center tones being split into three blocks of 280 data tones each. Thirteen symbols for common phase estimation are irregularly spaced among the data tones. The tones on either extreme of the 840 tones are padded with zeros. The transmitted information is encoded onto the data symbols using the coding level identified in the header slot for that frame.

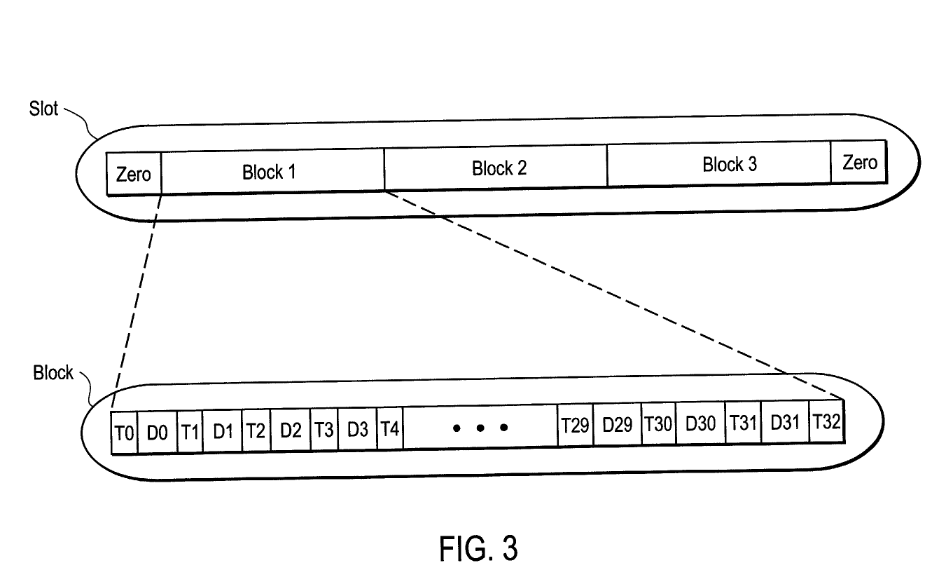

FIG. 3 illustrates one embodiment of a data-with-training slot illustrated in the frequency domain. A data-with-training slot is used in high mobility situations and where channel conditions change frequently. In one embodiment, each slot has 1024 tones, 855 of the center tones being split into three blocks of 285 tones and the balance of tones at either extreme padded with zeros. Each block has 32 sets of symbols (D0 . . . D31) interspersed with 33 training symbols (T0 . . . T32). In the time domain, the slot is further padded using a cyclic prefix and cyclic extensions according to well-known methods.

It will be apparent to one skilled in the art that the training symbols may be embedded within the data symbols according to numerous arrangements. In one embodiment, a wireless system may employ several slot arrangements having different training tone locations and/or training tone densities such that a different slot arrangement can be periodically selected and interpolation performed according to the selected slot arrangement. In one embodiment, a first portion of the selected slot is assigned to the first subsciber unit and a second portion of the selected slot is assigned to a second subscriber unit. The first subscriber unit interpolates the first portion of the slot arrangement to produce a first channel estimate and the second subscriber unit interpolates the second portion of the slot arrangement to produce a second channel estimate.

In one embodiment, the training symbols are embedded within the data symbols over frequency and the interpolation is performed across frequency. However, the present invention is not limited to any particular method of interpolation. In one embodiment, the training symbols are embedded within the data symbols across at least one of time, frequency and code and interpolation is performed across at least one of time, frequency and code.

In one embodiment, each slot is independently assigned to a single subscriber unit. Alternatively, each block is independently assigned to a subscriber unit. In one embodiment, the wireless system employs a multiple access protocol, such as frequency division multiple access, code division multiple access, time division multiple access, space division multiple access, wavelength division multiple access, and wavelet division multiple access. In a preferred embodiment, the wireless system employs time division multiple access over orthogonal frequency division multiplexing.

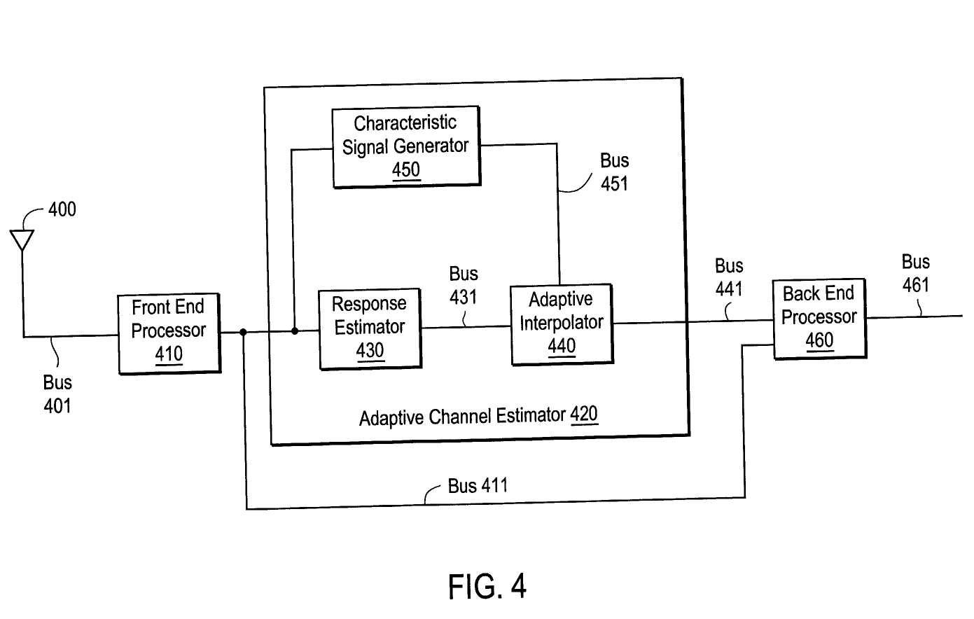

FIG. 4 illustrates an embodiment of a subscriber unit of the present invention. In this example, the subscriber unit uses the Multichannel, Multipoint Distribution Service (MMDS) bands in the 2.5 to 2.686 gigahertz range. However, the present invention is not limited to any particular frequency band. In this example, subscriber unit processes a signal that is a sequence of slots having training symbols embedded within data symbols according to the format shown with reference to FIG. 3. However, the present invention is not limited to any particular signal format.

The subscriber unit includes a front end processor 410 coupled to receive a signal from an antenna 400 on a bus 401 to generate a slot on a bus 411, an adaptive channel estimator 420 coupled to receive the slot on the bus 411 to generate a channel estimate on a bus 441, and a back end processor 460 coupled to receive the channel estimate on the bus 441 and to receive the slot on the bus 411 and configured to decode the transmitted information onto a bus 461. The adaptive channel estimator 420 includes a response estimator 430 coupled to receive the slot on the bus 411 and configured to generate training channel responses on a bus 431, a characteristic signal generator 450 coupled to receive the slot on the bus 411 and generate a characteristic signal on a bus 451, and an adaptive interpolator 440 coupled to receive the training channel responses on the bus 431 and the characteristic signal on the bus 451 to generate a channel estimate on the bus 441.

The front-end processor 410 downconverts the signal, performs synchronization with respect to the transmitter, blocks and windows a slot, and removes the cyclic prefix and extensions according to well-known methods. Alternatively, the front-end processor 410 is configured to process the signal according to other methods.

In one embodiment, the response estimator 430 receives the slot and performs a 1024 point Fast Fourier Transform (FFT) using a sampling rate of 2.268 MHz to produce 1024 tones, each having a bandwidth of approximately 2.23 kHz. Some of the 1024 tones are training symbols. In one embodiment, the location and density of the training tones are fixed. In another embodiment, the location and density of the training tones are provided in the header slot for the frame. In yet another embodiment, the training tones may be data tones that have been correctly demodulated by the receiver.

The characteristic signal generator 450 generates a characteristic signal, based on one or more estimated system characteristics, such as delay spread, Doppler spread, noise, and interference, and/or one or more deterministic system characteristics, such as modulation order, training tone locations, training tone density, number of transmit antennas, spatial configuration of the transmit antennas and transmit diversity mode.

In one embodiment, the characteristic signal generator 450 is coupled to receive at least a portion of the signal on the bus 411 to estimate at least one of the system characteristics. In another embodiment, the characteristic signal generator 450 is coupled to receive at least a portion of the training channel responses on the bus 431 to estimate at least one of the system characteristics.

In one embodiment, the characteristic signal generator 450 performs signal processing to estimate system characteristics such as delay spread, noise, and interference. In yet another embodiment, the characteristic signal generator 450 decodes slots to access information such as the training tone location, training tone density, and transmit diversity mode to generate the characteristic signal. The present invention is not limited to any particular method or apparatus to generate the characteristic signal.

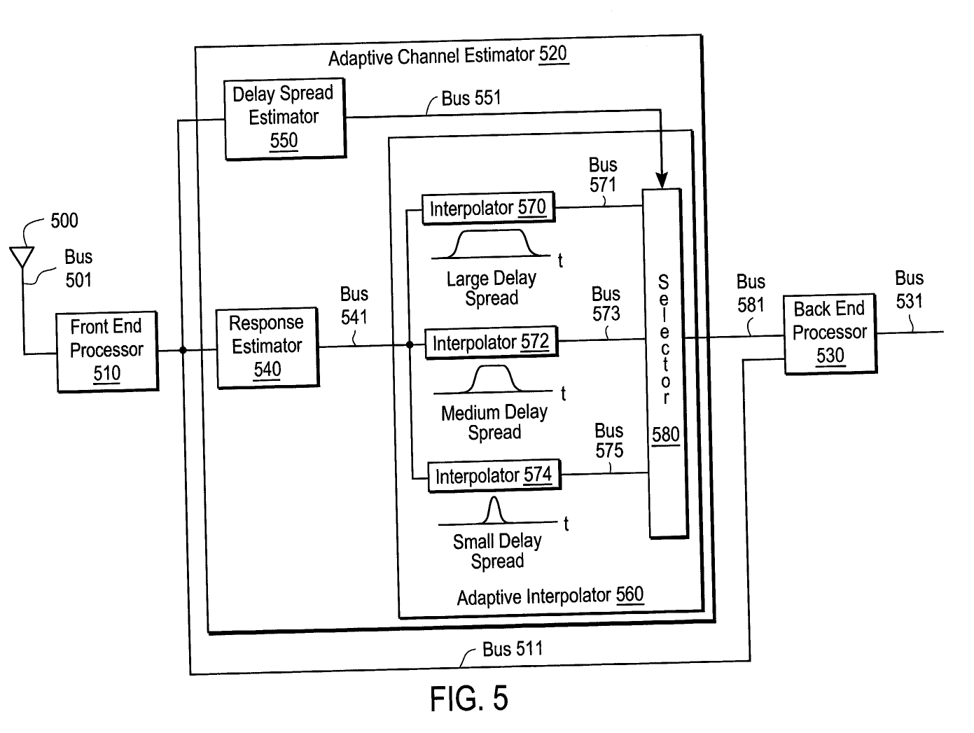

The adaptive interpolator 440 receives the training channel responses and interpolates the training channel responses to generate the data channel responses. The adaptive interpolator 440 adapts the interpolation according to the system characteristics indicated by the characteristic signal. FIG. 5 illustrates one implementation of the adaptive interpolator 440. However, the present invention is not limited to any particular method or apparatus of adapting the interpolator according to a characteristic signal. In one embodiment, the adaptive interpolator 440 includes a processor to compute and update filter parameters based on the characteristic signal. In another embodiment, one or more components of the adaptive interpolator 440 are selected or modified according to the characteristic signal such that the adaptive interpolator 440 is thereby adapted.

The back end processor 460 equalizes the data tones of the slot on the bus 411 using the channel estimate on the bus 441, performs common amplitude and phase error correction and decodes the signal to produce the transmitted information on the bus 461. More accurate channel estimates generally produce more accurate equalization. More accurate equalization generally leads to more accurate decoding. More accurate decoding generally leads to lower error rates. Lower error rates generally allow higher coding levels and enable higher transmission rates.

In an alternative embodiment, the front end processor 410 receives multiple signals from multiple transmit antennas and performs the downconversion, synchronization, blocking and windowing on the multiple signals to produce multiple slots on the bus 411. In one embodiment, the synchronization of each signal is performed with respect to the corresponding transmit antenna using the training tones corresponding to that transmit antenna. The characteristic signal generator 450 is configured to receive multiple slots corresponding to signals over different transmit-receive antenna pairs and generates a characteristic signal on the bus 451. In one embodiment, a portion of the characteristic signal corresponds to the one or more system characteristics for each of the slots. The adaptive interpolator 440 is configured to interpolate training channel responses to generate data channel responses for the data symbols. In one embodiment, the interpolation for each set of training channel responses is independently adapted according to the portion of the characteristic signal corresponding to that set of training channel responses. In an alternative embodiment, the interpolator for each set of training channel responses is adapted based on a portion of the characteristic signal that is common to the training channel responses for the signals received by all the receive antennas.

In one embodiment, the subscriber unit includes multiple receive antennas and the apparatus to decode the signals received by the antenna 400 is replicated and each instance is coupled to a corresponding receive antenna to process the signals received by that antenna as described herein. In one embodiment, the back end processor 460 is coupled to receive the channel estimates and slots from each instance of the apparatus and perform decoding for all the signals.

In one embodiment, the subscriber unit includes multiple adaptive interpolators, each configured to receive one block in a slot and to perform interpolation across the training symbols corresponding to that block. Each adaptive interpolator adapts according to the system characteristics corresponding to that block.

FIG. 5 illustrates one embodiment of a subscriber unit of the present invention. The subscriber unit includes a front end processor 510 coupled to receive a signal from an antenna 500 on a bus 501 to generate a slot on a bus 511, an adaptive channel estimator 520 coupled to receive the slot on the bus 511 to generate a channel estimate on a bus 581, and a back end processor 530 to receive the channel estimate on the bus 581 and to receive the slot on the bus 511 and configured to decode the transmitted information on a bus 531. The adaptive channel estimator 520 includes a response estimator 540 coupled to receive the slot on the bus 511 and configured to generate training channel responses on a bus 541, a delay spread estimator 550 coupled to receive the slot on the bus 511 and generate a characteristic signal on a bus 551, and an adaptive interpolator 560.

The front end processor 510, the back end processor 530, and the response estimator 540 perform as described for the front end processor 410, the back end processor 460, and the response estimator 430, respectively, in the embodiment of the subscriber unit shown in FIG. 4.

The delay spread estimator 550 estimates the delay spread and generates a characteristic signal based on the estimated delay spread. In one embodiment, the delay spread estimator 550 is coupled to receive at least a portion of the signal on the bus 511 to estimate the delay spread. In another embodiment, the delay spread estimator 550 is coupled to receive at least a portion of the channel estimate on the bus 541 to estimate the delay spread. In yet another embodiment, the delay spread estimator 550 decodes header slots to access information to estimate the delay spread.

In one embodiment, the delay spread estimator 550 estimates the delay spread by estimating the correlation coefficient between two adjacent (or nearby) training tones. The correlation coefficient is inversely proportional to delay spread. Equation 1 below shows a formula for estimating a correlation coefficient, ρ, for each transmit-receive antenna pair in a system having training tones spaced every 9 tones. N is the number of training tones for each transmit antenna and H is the training channel response for each transmit-receive antenna pair.

$$ρ = \frac{{\sum }_{k = 0}^{N - 1} {H}_{9 k} {H}_{9 k + 9}^{*}}{{\sum }_{k = 0}^{N - 1} {H}_{9 k} {H}_{9 k}^{*}} \qquad Equation 1$$

Alternatively, well-known time-domain correlation techniques may be used to compute delay spread. For example, the training symbols as transmitted (known at the receiver) can be correlated with the training symbols as received. The location of the peaks in the correlation indicates a multipath for the channel. The time difference between the first and last significant peak approximates the delay spread for the channel. The delay spread estimator 550 is not limited to any particular method or apparatus to estimate the delay spread.

The adaptive interpolator 560 includes an interpolator 570, an interpolator 572, and an interpolator 574, each receiving the training channel responses on the bus 541 and generating data channel responses by interpolating the training channel responses. The interpolator 570 is optimized to generate the data channel responses for a large delay spread. The interpolator 572 is optimized to generate the data channel responses for a medium delay spread. The interpolator 574 is optimized to generate the data channel responses for a small delay spread.

A selector 580 receives data channel responses from the interpolator 570 on a bus 571, the data channel responses from the interpolator 572 on a bus 573, and the data channel responses from the interpolator 574 on a bus 575, and selects one of the data channel responses according to the characteristic signal and transmits the selected data channel responses to the bus 581. In one embodiment, the selector 580 uses the correlation coefficient encoded in the characteristic signal to perform a table lookup to determine one of a number of interpolators to select. One method of determining the relationship between the correlation coefficient and the delay spread can be determined using simulation. For example, simulation may be done to determine the optimal values for ρ0 and ρ1 in Table 1.

TABLE 1

| Correlation | | |
|---|---|---|
| Coefficient | Delay Spread | Interpolators |
| 0 to ρ0 | Large | Interpolator 570 |
| ρ0 to ρ1 | Medium | Interpolator 572 |
| ρ1 to 1 | Small | Interpolator 574 |

If the correlation is between zero and ρ0, the delay spread is large and the selector 580 generates selects the data channel responses on the bus 571. If the correlation is between ρ0 and ρ1, the delay spread is medium and the selector 580 selects the data channel responses on the bus 573. If the correlation is between ρ1 and one, the delay spread is small and the selector 580 selects the data channel responses on the bus 575. The selector 580 transmits the selected data channel responses to the bus 581.

The back end processor receives the channel estimate on the bus 581 and the slot on the bus 511 and decodes the transmitted information on the bus 531.

The adaptive interpolator 560 adapts by using the characteristic signal to select one of a set of interpolators, the selected interpolator being the one that is best suited for the delay spread indicated by the characteristic signal. It will be apparent to one skilled in the art that the adaptive interpolator 560 may be configured to select between interpolators that are optimized for one or more system characteristics. For example, the characteristic signal may be generated based on at least one of delay spread, Doppler spread, noise, interference, modulation order, training tone location, training tone density, number of transmit antennas, spatial configuration of transmit antennas, and/or transmit diversity mode.

In one embodiment, the subscriber unit includes multiple receive antennas and the apparatus to decode the signals received by the antenna 500 is replicated and each instance of the apparatus is coupled to a corresponding receive antenna to process the signals received by that antenna as described herein. In one embodiment, the back end processor 530 is coupled to receive the channel estimates and slots from each instance of the apparatus and perform decoding for the signals received by all the receive antennas.

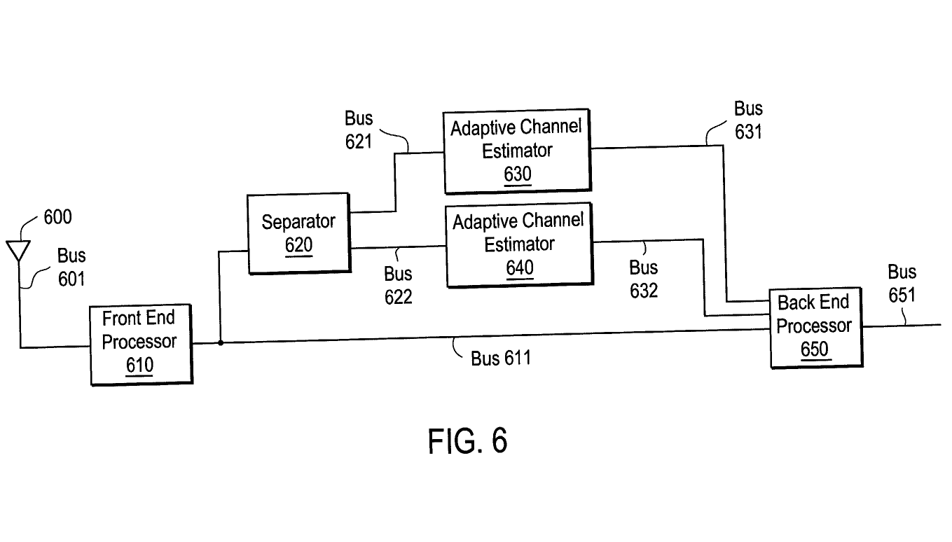

FIG. 6 illustrates one embodiment of a wireless system for receiving signals from two transmit antennas. The wireless system includes a front end processor 610 coupled to receive signals from an antenna 600 on a bus 601 to generate slots on a bus 611, a separator 620 coupled to receive the slots on the bus 611 and separate the slots onto a bus 621 and a bus 622, an adaptive channel estimator 630 coupled to receive the slot on the bus 621 and generate data channel responses on a bus 631, an adaptive channel estimator 640 coupled to receive the slot on the bus 622 and generate data channel responses on a bus 632, and a back end processor 650 coupled to receive the data channel responses on the bus 631, the data channel responses on the bus 632 and the slots on the bus 611 and decode the transmitted information on the bus 651.

The antenna 600 receives a first signal from a first transmitter and a second signal from a second transmitter, each signal having training symbols embedded within data symbols. The front end processor 610 downconverts the signals, performs synchronization with respect to the transmitter, blocks and windows the slots, and removes the cyclic prefix and extensions according to well-known methods.

The separator 620 separates the training symbols corresponding to the first signal from the training symbols corresponding to the second signal. The training tones corresponding to the first signal are received by the adaptive channel estimator 630 and the training tones corresponding to the second signal are received by the adaptive channel estimator 640. In one embodiment, the training symbols for the first signal are separated from the training symbols for the second symbol by frequency. In alternative embodiments, the training symbols for the first signal are separated from the training symbols for the second symbol by at least one of time, frequency and code.

The adaptive channel estimator 630 and the adaptive channel estimator 640 are configured to operate as described herein with respect to the adaptive channel estimators of FIGS.3 and 4.

The back end processor 650 receives the channel estimate corresponding to the first signal and the channel estimate corresponding to the second signal and the first and second signals.

The back end processor 650 equalizes the symbols using the channel response, performs common amplitude and phase error correction and decodes the slot to produce the transmitted information. In transmit diversity mode, the maximum ratio combining algorithm is used for equalization. In spatial multiplexing mode, a minimum mean square error equalizer is employed for separating the data streams transmitted onto independent transmitter antennas. More accurate channel estimates generally leads to lower error rates. Lower error rates generally allow higher coding levels which enable higher transmission rates.

In one embodiment, the subscriber unit includes multiple receive antennas and the apparatus to decode the signals received by the antenna 600 is replicated and each instance is coupled to a corresponding receive antenna to process the signals received by that antenna as described herein. In one embodiment, the back end processor 650 is coupled to receive the channel estimates and slots from each instance of the apparatus and perform decoding for the signals received by all the receive antennas.

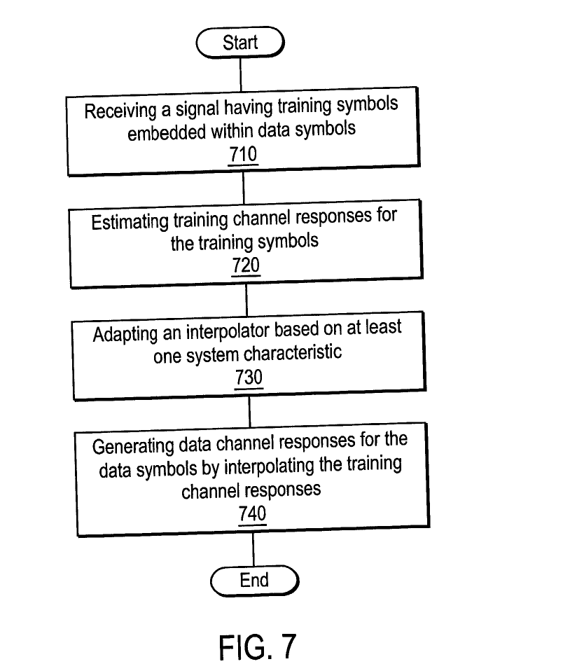

FIG. 7 illustrates one embodiment of a method of the present invention with reference to the wireless system of FIG. 1. However, the method may be applied to the wireless system of FIG. 2 as well as other wireless systems employing channel estimation.

In step 710, a signal having training symbols embedded within data symbols is received. For example, with reference to FIG. 1, the first signal can be transmitted from the transmit antenna 111 through a channel 121 to be received by the receive antenna 131.

In step 720, the training channel responses are estimated for the training symbols. In one embodiment, an FFT is performed on the signal to produce the training channel responses.

In step 730, an interpolator is adapted based on at least one system characteristic. The present invention is not limited to any particular method or apparatus of adapting the interpolator according to one or more system characteristics. In one embodiment, one or more components of the adaptive interpolator are selected or modified according to at least one system characteristic such that the adaptive interpolator is thereby adapted. For example, in an embodiment using the adaptive channel estimator 520 of FIG. 5, one of the set of the interpolator 570, the interpolator 572, and the interpolator 574 may be selected based on an estimated delay spread. In another embodiment, the adaptive interpolator includes a processor to compute and update filter parameters based on at least one system characteristic.

In one embodiment, an interpolator for each transmit-receive pair is adapted based on at least one system characteristic.

In step 740, the data channel responses for the data symbols are generated by interpolating the training channel responses for the training symbols. In one embodiment, the interpolation is adapted according to at least one system characteristic to perform more accurate channel estimation for the indicated system characteristics. More accurate channel estimation generally reduces error rates for a given data transmission rate and/or increases data transmission rates for given error rate.

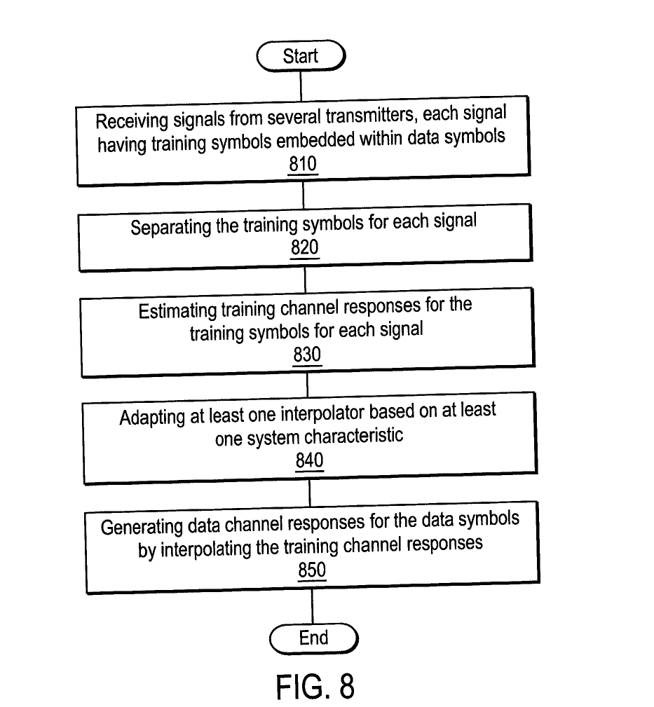

FIG. 8 illustrates one embodiment of a method of the present invention with reference to the wireless system of FIG. 2 as well as other systems employing channel estimation.

In step 810, a first signal from a first transmitter and a second signal from a second transmitter are received. The first and second signal have training symbols embedded within data symbols.

In step 820, the training symbols for the first signal are separated from the training symbols for the second signal. In one embodiment, the training symbols for the first signal are separated from the training symbols for the second symbol by frequency. In alternative embodiments, the training symbols for the first signal are separated from the training symbols for the second symbol by at least one of time, frequency and code.

In an alternative embodiment, the training symbols for the first signal are not separated from the training symbols for the second signal.

In step 830, the training channel responses are estimated for the training symbols for the first and second signals.

In step 840, at least one interpolator is adapted based on at least one system characteristic. As explained with reference to step 730 of FIG. 7, the present invention is not limited to any particular method or apparatus of adapting interpolators according to one or more system characteristics. In one embodiment, the interpolators are adapted based on system characteristics applied to all the interpolators. Alternatively, the interpolators are independently adapted based on the system characteristics independently applied to each interpolator.

In step 850, for each signal, the data channel responses for the data symbols are generated by interpolating the training channel responses for the training symbols. In one embodiment, the interpolation is adapted according to at least one system characteristic to perform more accurate channel estimation for the indicated system characteristics. More accurate channel estimation generally reduces error rates for a given data transmission rate and/or increases data transmission rates for given error rate.

In one embodiment of a wireless system of the present invention, the base station controller includes an adaptive channel estimator that adapts to one or more system characteristics and the base station controller performs channel estimation on one or more signals transmitted by the subscriber unit to one or more antennas controlled by the base station controller.

In this detailed description, numerous specific details are set forth in order to illustrate the present invention by example. This detailed description is not meant to exhaustive or to limit the invention to the precise description. Some of the specific details need not be used to practice the invention. In other instances, well-known structures, signals, and methods have not been shown or described. It will be apparent to one skilled in the art that many modifications and variations of the examples described herein are within the spirit and scope of the present invention. It is intended that the scope of the invention be defined by the following claims and their equivalents.

What is claimed is:

1. A method of performing channel estimation in a wireless system comprising the steps of:
receiving a signal comprising a plurality of training symbols embedded within a plurality of data symbols;
estimating a plurality of training channel responses for the plurality of training symbols; and
adapting an interpolator for generating a plurality of data channel responses for the plurality of data symbols by interpolating the plurality of training channel responses.

2. The method of claim 1 wherein the interpolator is adaptively modified based on at least one system characteristic.

3. The method of claim 2, further comprising the step of:
generating a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein the interpolator is adaptively modified based on the characteristic signal.

4. The method of claim 1 wherein each of the plurality of training symbols are embedded within the plurality of data symbols over at least one of time, frequency, and code, further comprising the step of:
generating a data channel response for each of the plurality of data symbols by interpolating the plurality of training channel responses across at least one of time, frequency, and code.

5. The method of claim 1 further comprising the step of generating the signal using at least one of an orthogonal frequency division multiplex protocol, a code division multiplex protocol, a wavelet transform protocol, a frequency hopping protocol and a single carrier protocol.

6. A method of performing channel estimation in a wireless system comprising the steps of:
receiving a plurality of signals from a plurality of transmitters, each of the plurality of signals comprising a plurality of training symbols embedded within a corresponding plurality of data symbols;
estimating a plurality of training channel responses for each plurality of training symbols; and
adapting at least one interpolator for generating a plurality of data channel responses for each plurality of data symbols by interpolating the plurality of training channel responses for the corresponding plurality of training symbols.

7. The method of claim 6 wherein at least one interpolator is adaptively modified based on at least one system characteristic.

8. The method of claim 7, further comprising the step of generating a characteristic signal based on at least one of an estimated delay spread, an estimated Doppler spread, an estimated noise, an estimated interference, a modulation order, a training tone locations a training tone density, a number of transmit antennas, a spatial configuration of transmit antennas, and a transmit diversity mode, wherein at least one interpolator is adaptively modified based on the characteristic signal.

9. The method of claim 6 wherein each plurality of training symbols are embedded within the corresponding plurality of data symbols over at least one of time, frequency, and code, further comprising the step of:
generating the plurality of data channel responses for each plurality of data symbols by interpolating the plurality of training channel responses for the corresponding plurality of training symbols across at least one of time, frequency, and code.

10. The method of claim 6 further comprising the step of generating the plurality of signals using at least one of an orthogonal frequency division multiplex protocol, a code division multiplex protocol, a wavelet transform protocol, a frequency hopping protocol and a single carrier protocol.

11. The method of claim 6 further comprising the steps of separating each plurality of training symbols by at least one of time, frequency, and code.

12. A method of performing channel estimation in a wireless system comprising the steps of:
receiving a signal comprising a plurality of training symbols embedded within a plurality of data symbols;
estimating a plurality of training channel responses for the plurality of training symbols; and
selecting at least one of a plurality of interpolators for generating a plurality of data channel responses for the plurality of data symbols by interpolating the plurality of training channel responses.

13. The method of claim 12 wherein at least one of the plurality of interpolators is selected based on at least one system characteristic.

14. The method of claim 13, further comprising the step of generating a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein at least one of the plurality of interpolators is selected based on the characteristic signal.

15. The method of claim 12 wherein each of the plurality of training symbols are embedded within the plurality of data symbols over at least one of time, frequency, and code, further comprising the step of:
generating a data channel response for each of the plurality of data symbols by interpolating the plurality of training channel responses across at least one of time, frequency, and code.

16. The method of claim 12 further comprising the step of generating the signal using at least one of an orthogonal frequency division multiplex protocol, a code division multiplex protocol, a wavelet transform protocol, a frequency hopping protocol and a single carrier protocol.

17. A method of performing channel estimation in a wireless system comprising the steps of:
receiving a plurality of signals from a plurality of transmitters, each of the plurality of signals comprising a plurality of training symbols embedded within a corresponding plurality of data symbols;
estimating a plurality of training channel responses for each plurality of training symbols; and
selecting at least one of a plurality of interpolators for generating a plurality of data channel responses for each plurality of data symbols by interpolating the plurality of training channel responses for the corresponding plurality of training symbols.

18. The method of claim 17 wherein at least one of the plurality of interpolators is selected based on at least one system characteristic.

19. The method of claim 18, further comprising the step of generating a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein at least one of the plurality of interpolators is selected based on the characteristic signal.

20. The method of claim 17 wherein each plurality of training symbols are embedded within the corresponding plurality of data symbols over at least one of time, frequency, and code, further comprising the step of:
generating the plurality of data channel responses for each plurality of data symbols by interpolating the plurality of training channel responses for the corresponding plurality of training symbols across at least one of time, frequency, and code.

21. The method of claim 17 further comprising the step of generating the plurality of signals using at least one of an orthogonal frequency division multiplex protocol, a code division multiplex protocol, a wavelet transform protocol, a frequency hopping protocol and a single carrier protocol.

22. The method of claim 17 further comprising the step of: separating each plurality of training symbols by at least one of time, frequency, and code.

23. A subscriber unit for receiving a signal comprising a plurality of training symbols embedded within a plurality of data symbols, the subscriber unit comprising:
a response estimator for estimating a plurality of training channel responses for the plurality of training symbols; and
an adaptive interpolator for generating a plurality of data channel responses for the plurality of data symbols by interpolating the plurality of training channel responses.

24. The subscriber unit of claim 23 wherein the adaptive interpolator is adaptively modified based on at least one system characteristic.

25. The subscriber unit of claim 24, further comprising a characteristic signal generator configured to generate a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein the adaptive interpolator is adaptively modified based on the characteristic signal.

26. The subscriber unit of claim 23 wherein each of the plurality of training symbols are embedded within the plurality of data symbols over at least one of time, frequency, and code, the adaptive interpolator being configured to generate a data channel response for each of the plurality of data symbols by interpolating the plurality of training channel responses across at least one of time, frequency, and code.

27. The subscriber unit of claim 23 wherein the signal comprises at least one of an orthogonal frequency division multiplex protocol, a code division multiplex protocol, a wavelet transform protocol, a frequency hopping protocol and a single carrier protocol.

28. A subscriber unit for receiving a signal comprising a plurality of training symbols embedded within a plurality of data symbols, the subscriber unit comprising:
a response estimator for estimating a plurality of training channel responses for the plurality of training symbols; and
a selector for selecting at least one of a plurality of interpolators for generating a plurality of data channel responses for the plurality of data symbols by interpolating the plurality of training channel responses.

29. The subscriber unit of claim 28 wherein the selector is configured to select at least one of the plurality of interpolators based on at least one system characteristic.

30. The subscriber unit of claim 29, wherein a characteristic signal generator is configured to generate a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein the selector is configured to generate a selection signal based on the characteristic signal.

31. The subscriber unit of claim 28 wherein each of the plurality of training symbols are embedded within the plurality of data symbols over at least one of time, frequency, and code, the plurality of interpolators being configured to generate a data channel response for each of the plurality of data symbols by interpolating the plurality of training channel responses across at least one of time, frequency, and code.

32. The subscriber unit of claim 28 wherein the signal comprises at least one of an orthogonal frequency division multiplex protocol, a code division multiplex protocol, a wavelet transform protocol, a frequency hopping protocol and a single carrier protocol.

33. A wireless system comprising:
a transmitter for transmitting a signal comprising a plurality of training symbols embedded within a plurality of data symbols; and
a subscriber unit comprising:
a response estimator for estimating a plurality of training channel responses for the plurality of training symbols; and
an adaptive interpolator for generating a plurality of data channel responses for the plurality of data symbols by interpolating the plurality of training channel responses.

34. The wireless system of claim 33 wherein the adaptive interpolator is adaptively modified based on at least one system characteristic.

35. The wireless system of claim 34, further comprising a characteristic signal generator configured to generate a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein the adaptive interpolator is adaptively modified based on the characteristic signal.

36. The wireless system of claim 33 wherein each of the plurality of training symbols are embedded within the plurality of data symbols over at least one of time, frequency, and code, the adaptive interpolator being configured to generate a data channel response for each of the plurality of data symbols by interpolating the plurality of training channel responses across at least one of time, frequency, and code.

37. The wireless system of claim 33 wherein the signal comprises at least one of an orthogonal frequency division multiplex protocol, a code division multiplex protocol, a wavelet transform protocol, a frequency hopping protocol and a single carrier protocol.

38. A wireless system comprising:
a plurality of transmitters for transmitting a plurality of signals, each of the plurality of signals comprising a plurality of training symbols embedded within a corresponding plurality of data symbols; and
a receiver comprising:
a response estimator for estimating a plurality of training channel responses for each plurality of training symbols; and
an adaptive interpolator for generating a plurality of data channel responses for each plurality of data symbols by interpolating the plurality of training channel responses for the corresponding plurality of training symbols.

39. The wireless system of claim 38 wherein at least one interpolator is adaptively modified based on at least one system characteristic.

40. The wireless system of claim 39, further comprising a characteristic signal generator configured to generate a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein at least one interpolator is adaptively modified based on the characteristic signal.

41. The wireless system of claim 38 wherein each plurality of training symbols are embedded within the corresponding plurality of data symbols over at least one of time, frequency, and code, the adaptive interpolator being configured to generate the plurality of data channel responses for each plurality of data symbols by interpolating the plurality of training channel responses for the corresponding plurality of training symbols across at least one of time, frequency, and code.

42. The wireless system of claim 38 wherein the plurality of signals comprise at least one of an orthogonal frequency division multiplex protocol, a code division multiplex protocol, a wavelet transform protocol, a frequency hopping protocol and a single carrier protocol.

43. The wireless system of claim 38 wherein the subscriber unit further comprises a separator configured to separate each plurality of training symbols by at least one of time, frequency, and code.

44. A wireless system comprising:
a transmitter for transmitting a signal comprising a plurality of training symbols embedded within a plurality of data symbols; and
a receiver comprising:
a response estimator for estimating a plurality of training channel responses for the plurality of training symbols; and
a selector for selecting at least one of a plurality of interpolators for generating a plurality of data channel responses for the plurality of data symbols by interpolating the plurality of training channel responses.

45. The wireless system of claim 44 wherein the selector is configured to select at least one of the plurality of interpolators based on at least one system characteristic.

46. The wireless system of claim 45, further comprising a characteristic signal generator configured to generate a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein the selector is configured to generate a selection signal based on the characteristic signal, the selector being configured to select at least one of the plurality of interpolators based on the selection signal.

47. The wireless system of claim 44 wherein each of the plurality of training symbols are embedded within the plurality of data symbols over at least one of time, frequency, and code, the selector being configured to generate a data channel response for each of the plurality of data symbols by interpolating the plurality of training channel responses across at least one of time, frequency, and code.

48. The wireless system of claim 44 wherein the signal comprises at least one of an orthogonal frequency division multiplex protocol, a code division multiplex protocol, a wavelet transform protocol, a frequency hopping protocol and a single carrier protocol.

49. A wireless system comprising:
a plurality of transmitters for transmitting a plurality of signals, each of the plurality of signals comprising a plurality of training symbols embedded within a corresponding plurality of data symbols; and
a receiver comprising:
a response estimator for estimating a plurality of training channel responses for each plurality of training symbols; and
a selector for selecting one of a plurality of interpolators for generating a plurality of data channel responses for each plurality of data symbols by interpolating the plurality of training channel responses for the corresponding plurality of training symbols.

50. The wireless system of claim 49 wherein at least one interpolator is selected based on at least one system characteristic.

51. The wireless system of claim 50, further comprising a characteristic signal generator configured to generate a characteristic signal based on at least one of an estimated delay spread, an estimated Doppler spread, an estimated noise, an estimated interference, a modulation order, a training tone location, a training tone density, a number of transmit antennas, a spatial configuration of transmit antennas, and a transmit diversity mode, wherein the selector generates a selection signal based on the characteristic signal, the selector being configured to select at least one of the plurality of interpolators based on the selection signal.

52. The wireless system of claim 49 wherein each plurality of training symbols are embedded within the corresponding plurality of data symbols over at least one of time, frequency, and code, the plurality of interpolators being configured to generate the plurality of data channel responses for each plurality of data symbols by interpolating the plurality of training channel responses for the corresponding plurality of training symbols across at least one of time, frequency, and code.

53. The wireless system of claim 49 wherein the plurality of signals comprise at least one of an orthogonal frequency division multiplex protocol, a code division multiplex protocol, a wavelet transform protocol, a frequency hopping protocol and a single carrier protocol.

54. The wireless system of claim 49 wherein the subscriber unit further comprises a separator configured to separate each plurality of training symbols by at least one of time, frequency, and code.
